(19) United States
(12) Patent Application Publication
(10) Pub. No.: US 2014/0012018 A1
(43) Pub. Date: Jan. 9, 2014

(54) SULFOLANE COMPOSITION

(71) Applicants: Masayoshi Miyada, Hyogo (JP); Katsumi Takano, Hyogo (JP); Hisaaki Kanda, Hyogo (JP)

(72) Inventors: Masayoshi Miyada, Hyogo (JP); Katsumi Takano, Hyogo (JP); Hisaaki Kanda, Hyogo (JP)

(73) Assignee: SUMITOMO SEIKA CHEMICALS CO., LTD., Hyogo (JP)

(21) Appl. No.: 13/979,953

(22) PCT Filed: Dec. 27, 2011
(86) PCT No.: PCT/JP2011/080155

§ 371 Date: Sep. 12, 2013

(30) Foreign Application Priority Data
Jan. 18, 2011 (JP) 2011-007402
Nov. 17, 2011 (JP) 2011-251396

(51) Int. Cl. C09K 3/00

(52) U.S. Cl. CPC C09K 3/00
USPC 549/83

(57) ABSTRACT

The present invention aims to provide, with combination of a sulfolane compound and an organic alkanolamine compound, a sulfolane composition which is not likely to cause odor, can suppress pyrolysis of the sulfolane compound with a reduced amount of additives, and can reduce generation of sulfur dioxide. The present invention relates to a sulfolane composition containing a sulfolane compound represented by formula (1) and an organic alkanolamine compound, wherein R¹ to R⁶ each independently represent a hydrogen atom or a C₁₋₆ alkyl group.

### TECHNICAL FIELD

The present invention relates to a sulfolane composition which suppresses generation of odor and discoloration, and has better heat resistance.

### BACKGROUND ART

Sulfolane compounds are aprotic polar solvents which have a higher polarity and a higher boiling point than other polar solvents. Sulfolane compounds also have a good ability to polarize and dissolve the reactant, and thus have been used, for example, in the following: an extraction solvent for compounds (e.g. benzene, toluene, xylene), an acid gas remover, low-boiling-point alcohol separation, fractional distillation of wood tar, a reaction solvent for aromatic compounds, and a solvent for electronic component production (Patent Literatures 1 and 2).

Sulfolane compounds, however, tend to be pyrolyzed gradually under high temperatures to produce sulfurous acid gas (sulfur dioxide) which may possibly cause problems such as corrosion of the metallic inner wall of the reactor and the equipment, and inhibition of the target reaction. There are methods developed to suppress generation of sulfur dioxide due to pyrolysis of sulfolane compounds under high temperatures, namely addition of an organosulfur compound (Patent Literature 3) and addition of a weakly basic organic compound, a nitroxy radical antioxidant, a hindered phenolic antioxidant, a basic inorganic substance, or a hindered amine antioxidant (Patent Literature 4).

### CITATION LIST

### Patent Literature

Patent Literature 1: JP H10-88017 A
Patent Literature 2: JP 2004-323544 A
Patent Literature 3: JP H11-255765 A
Patent Literature 4: JP 2009-215369 A

### SUMMARY OF INVENTION

### Technical Problem

The method of Patent Literature 3, however, includes adding an organosulfur compound which unfortunately causes odor even when used in a small amount. The method of Patent Literature 4 uses a relatively large amount of additive(s), and thus is not economically preferable.

The present invention relates to a sulfolane composition containing an organic alkanolamine compound, which is an additive, mixed with a sulfolane compound. With this combination of a sulfolane compound and an organic alkanolamine compound, the present invention aims to provide a sulfolane composition which is not likely to cause odor and discoloration, can suppress pyrolysis of the sulfolane compound with a reduced amount of additives, and can reduce generation of sulfur dioxide.

The “sulfolane composition” as used herein refers to a composition containing a sulfolane compound.

### Solution to Problem

The present invention relates to a sulfolane composition containing a sulfolane compound represented by formula (1) and an organic alkanolamine compound,

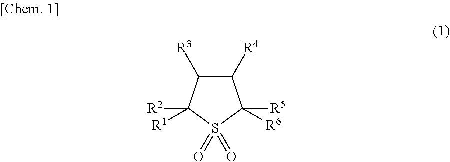

wherein R¹ to R⁶ each independently represent a hydrogen atom or a C₁₋₆ alkyl group.

Hereinafter, the present invention is described in detail.

Examples of the C₁₋₆ alkyl group represented by any of R¹ to R⁶ in formula (1) include methyl, ethyl, propyl, butyl, hexyl, isobutyl, and tert-butyl.

Specific examples of the sulfolane compound represented by formula (1) include sulfolane, 3-methyl sulfolane, 3-ethyl sulfolane, 3-propyl sulfolane, 3-butyl sulfolane, 3-isobutyl sulfolane, 3-tert-butyl sulfolane, 3-hexyl sulfolane, 3,4-dimethyl sulfolane, 3,4-diethyl sulfolane, 3,4-dibutyl sulfolane, 3-hexyl-4-methyl sulfolane, 2,5-dimethyl sulfolane, 2,3,5-trimethyl sulfolane, 2,5-dimethyl-3-hexyl sulfolane, 2,3,4,5-tetramethyl sulfolane, 2,5-diethyl sulfolane, 2,5-diethyl-2-methyl sulfolane, 2,5-diethyl-2,5-dimethyl sulfolane, 2,5-diethyl-3,4-dimethyl sulfolane, 2,5-diethyl sulfolane, 2,5-dipropyl sulfolane, 2,5-dipropyl-3-methyl sulfolane, and 2,5-dipropyl-3,4-dimethyl sulfolane.

Among these, sulfolane is preferably used in terms of the cost and availability. Sulfolane compounds containing water can also be used. Here, the amount of water is not particularly limited.

The organic alkanolamine compound used in the present invention may have any physical properties, but preferably has a boiling point closer to that of the sulfolane compound for efficient suppression of pyrolysis of the sulfolane compound at high temperatures. The difference in the boiling point between the sulfolane compound and the organic alkanolamine compound is preferably within 150° C., and more preferably within 100° C.

The organic alkanolamine compound is preferably at least one selected from the group consisting of primary alkanolamine compounds, secondary alkanolamine compounds, and tertiary alkanolamine compounds.

Examples of the primary alkanolamine compounds include monoethanolamine, monoisopropanolamine, and monobutanolamine.

Examples of the secondary alkanolamine compounds include diethanolamine, diisopropanolamine, and dibutanolamine.

Examples of the tertiary alkanolamine compounds include triethanolamine, triisopropanolamine, and tributanolamine.

Among these, in terms of the cost and availability, primary alkanolamine compounds and secondary alkanolamine compounds are preferred, and at least one selected from the group consisting of monoethanolamine, diethanolamine, triethanolamine, monoisopropanolamine, diisopropanolamine, and triisopropanolamine is more preferred. These organic alkanolamine compounds may be used alone or in combination.

The amount of the organic alkanolamine compound is preferably 0.0001 to 0.4 parts by mass, and more preferably 0.005 to 0.1 parts by mass, for each 100 parts by mass of the sulfolane compound. An amount of the organic alkanolamine compound of less than 0.0001 parts by mass is not preferred because it may not suppress pyrolysis of the sulfolane compound, failing to reduce generation of sulfur dioxide. An amount of more than 0.4 parts by mass is not preferred because it may not achieve an effect commensurate with the amount, which is economically inefficient, and may also cause the odor of the alkanolamine compound.

How the organic alkanolamine compound can suppress pyrolysis of a sulfolane compound and reduce generation of sulfur dioxide has not been revealed. Assumingly, the organic alkanolamine compound or a salt resulting from the reaction between the organic alkanolamine compound and sulfur dioxide is involved in the decomposition scheme of the sulfolane compound to reduce generation of sulfur dioxide.

Examples of the method of mixing the sulfolane compound and the organic alkanolamine compound include, but not particularly limited to, a method of directly adding a predetermined amount of the organic alkanolamine compound to the sulfolane compound, and uniformly mixing the compounds with stirring.

The sulfolane composition of the present invention is not likely to cause odor and discoloration, and can, when used as a solvent, keep suppressing pyrolysis even when repeatedly recycled through heating and distillation.

### Advantageous Effects of Invention

The present invention can provide a sulfolane composition which is not likely to cause odor and discoloration, can suppress pyrolysis of a sulfolane compound, and can reduce generation of sulfur dioxide. The sulfolane composition of the present invention when used as a solvent can keep suppressing pyrolysis even when repeatedly recycled through heating and distillation.

### DESCRIPTION OF EMBODIMENTS

The present invention is described in more detail based on examples which, however, are not intended to limit the scope of the present invention.

In the examples and comparative examples, the amount of sulfur dioxide in the gas phase was measured by heat stability test 1 described below, and the amount of sulfur dioxide in the liquid phase was measured by heat stability test 2 described below.

### Examples 1 to 9

The organic alkanolamine compounds shown in Table 1 were added in the amounts shown in Table 1 to 250 mL (310 g) of the respective sulfolane compounds, so that sulfolane compositions were obtained. The sulfolane compositions thus obtained were subjected to the heat stability tests 1 and 2. The odor of the obtained sulfolane compositions, the results of the heat stability tests 1 and 2, and the appearance of the sulfolane compositions visually observed at 30° C. after the heat stability tests 1 and 2 are shown in Table 1.

### Comparative Example 1

The heat stability tests 1 and 2 were performed using only the sulfolane (250 mL) used in Examples 1 to 7, without an organic alkanolamine compound. The odor of the sulfolane used, the results of the heat stability tests 1 and 2, and the appearance of the sulfolane visually observed at 30° C. after the heat stability tests 1 and 2 are shown in Table 1.

### Comparative Examples 2 to 5

The additives shown in Table 1 were added in the amounts shown in Table 1 to 250 mL (310 g) of the respective sulfolane compounds, so that sulfolane compositions were obtained. The sulfolane compositions thus obtained were subjected to the heat stability tests 1 and 2. The odor of the obtained sulfolane compositions, the results of the heat stability tests 1 and 2, and the appearance of the sulfolane compositions visually observed at 30° C. after the heat stability tests 1 and 2 are shown in Table 1.

The TEMPO used in Comparative Example 5 was 2,2,6,6-tetramethyl-1-piperidin-1-oxyl.

### Comparative Example 6

The heat stability tests 1 and 2 were performed using only ethyl isopropyl sulfone (250 mL) without an organic alkanolamine compound. The odor of the ethyl isopropyl sulfone used, the results of the heat stability tests 1 and 2, and the appearance of the sulfolane visually observed at 30° C. after the heat stability tests 1 and 2 are shown in Table 1.

### [Heat Stability Test 1]

The whole amounts of the sulfolane compositions obtained in Examples 1 to 9 and Comparative Examples 2 to 6, the sulfolane in Comparative Example 1, and the sulfone in Comparative Example 6 each were put into a 500-mL flask. The sample in the flask was aerated with nitrogen gas at a flow rate of 83 mL/min. While the blown gas was introduced into a gas suction bottle containing a 3% solution of hydrogen peroxide (100 mL) as a sulfur dioxide-absorbing solution, the flask was heated such that the sample in the flask was heated to 180±2° C. in about 20 minutes. The sample was aerated with nitrogen gas for one hour at a flow rate of 83 mL/min with the sample temperature maintained at 180±2° C. Then, the sample was allowed to cool to a temperature of 100° C. while aerated with nitrogen gas at a flow rate of 40 mL/min. After the cooling, the suction bottle was taken out, and the amount of sulfur dioxide in the suction solution was determined by ion chromatography.

### [Heat Stability Test 2]

The whole amounts of the sulfolane compositions obtained in Examples 1 to 9 and Comparative Examples 2 to 6, the sulfolane in Comparative Example 1, and the sulfone in Comparative Example 6 each were put into a 500-mL flask. An oil bath was heated to a temperature of 180±2° C., and the flask was immersed in the bath. One hour later, the amount of sulfur dioxide in the sample in the flask was determined by ion chromatography.

### [Odor Sensory Evaluation]

One drop each of the sulfolane compositions obtained in Examples 1 to 9 and Comparative Examples 2 to 5, the sulfolane in Comparative Example 1, and the ethyl isopropyl sulfone in Comparative Example 6 was added to 300-mL stoppered Erlenmeyer flasks each containing distilled water (100 mL). The resulting mixtures were stirred for five minutes, and left to stand for one hour.

Subsequently, the odor in the 300-mL stoppered Erlenmeyer flasks was evaluated by five panelists (sensory evaluation testers) in accordance with the specified criteria “6-point odor intensity scale” mentioned below.

The average value of their results was taken as the evaluation result. The results are shown in Table 1.
5: Intense odor
4: Strong odor
3: Easily recognizable odor
2: Slight, but identifiable odor
1: Barely perceptible odor
0: No odor

TABLE 1

| | | | Amount of sulfur dioxide | | | | |
|---|---|---|---|---|---|---|---|
| | | | (mg/250 mL sulfolane | | | | |
| | | | compound or | | | | |
| | Additive | | ethyl isopropyl sulfone) | | Appearance (30° C.) | | |
| | | Amount for each 100 parts by mass of | Heat stability | Heat stability | Heat stability | Heat stability | |
| | Kind | sulfolane compound (parts by mass) | test 1 | test 2 | test 1 | test 2 | Odor |
| Example 1 | Monoethanol amine | 0.08 | Less than 1.0 | Less than 1.0 | Colorless | Colorless | 2.3 |
| | | (0.2500 g/250 mL sulfolane) | | | | | |
| Example 2 | Monoethanol amine | 0.008 | 4.0 | 4.3 | Colorless | Colorless | 2.1 |
| | | (0.0250 g/250 mL sulfolane) | | | | | |
| Example 3 | Monoethanol amine | 0.004 | 6.0 | 5.8 | Colorless | Colorless | 2.1 |
| | | (0.0125 g/250 mL sulfolane) | | | | | |
| Example 4 | Isopropanol amine | 0.004 | 6.4 | 6.7 | Colorless | Colorless | 2.1 |
| | | (0.0125 g/250 mL sulfolane) | | | | | |
| Example 5 | n-Butanol amine | 0.004 | 6.0 | 6.2 | Colorless | Colorless | 2.1 |
| | | (0.0125 g/250 mL sulfolane) | | | | | |
| Example 6 | Diethanol amine | 0.004 | 4.1 | 3.7 | Colorless | Colorless | 2.0 |
| | | (0.0125 g/250 mL sulfolane) | | | | | |
| Example 7 | Triethanol amine | 0.004 | 5.8 | 6.0 | Colorless | Colorless | 2.0 |
| | | (0.0125 g/250 mL sulfolane) | | | | | |
| Example 8 | Monoethanol amine | 0.004 | 6.2 | 6.0 | Colorless | Colorless | 2.1 |
| | | (0.0125 g/250 mL 3-methyl sulfolane) | | | | | |
| Example 9 | Monoethanol amine | 0.004 | 6.0 | 5.9 | Colorless | Colorless | 1.9 |
| | | (0.0125 g/250 mL 3,4-dimethyl | | | | | |
| | | sulfolane) | | | | | |
| Comparative | None | 0 | 90.2 | 85.1 | Colorless | Colorless | 2.0 |
| Example 1 | (sulfolane only) | | | | | | |
| Comparative | Octyl amine | 0.004 | 5.1 | 5.6 | Colorless | Colorless | 3.2 |
| Example 2 | | (0.0125 g/250 mL sulfolane) | | | | | |
| Comparative | Benzyl amine | 0.008 | 5.7 | 6.1 | Yellow | Yellow | 2.2 |
| Example 3 | | (0.0250 g/250 mL sulfolane) | | | | | |
| Comparative | Di-tert-butylsulfide | 0.08 | 35.4 | 34.0 | Colorless | Colorless | 5 |
| Example 4 | | (0.25 g/250 mL sulfolane) | | | | | |
| Comparative | TEMPO | 0.8 | 15.5 | 15.0 | Brown | Brown | 2.3 |
| Example 5 | | (2.50 g/250 mL sulfolane) | | | | | |
| Comparative | None | 0 | 10.2 | 10.0 | Colorless | Colorless | 2.5 |
| Example 6 | (ethyl isopropyl sulfone only) | | | | | | |

The results of Examples 1 to 9 and Comparative Example 1 show that the sulfolane compositions obtained in Examples 1 to 9 produced a reduced amount of sulfur dioxide, and suppressed pyrolysis of the sulfolane composition. Also, the results of Examples 1 to 9 and Comparative Examples 2 to 5 show that the sulfolane compositions obtained in Examples 1 to 9 suppressed generation of odor and discoloration. When a chain aliphatic sulfone is used as in the case of Comparative Example 6, no organic alkanolamine compound is required because such a sulfone has relatively good heat stability, differently from the case of using sulfolane compounds. Chain aliphatic sulfones, however, cannot achieve the properties of sulfolane compounds including high polarity, high boiling point, and excellent polarizing and dissolving ability for reactant.

### REFERENCE EXAMPLE 1

Simple distillation of each liquid obtained after the heat stability test 1 and 2 for the sulfolane composition of Example 2 was performed, and the whole amount of each distillate was mixed to obtain a sulfolane composition. The whole amount of each sulfolane composition thus obtained was put into a 500-mL flask, and further subjected to the heat stability tests 1 and 2. The results are shown in Table 2.

### Reference Example 2

Simple distillation of each liquid obtained after the heat stability test 1 and 2 for the sulfolane composition of Reference Example 1 was performed, and the whole amount of each distillate was mixed to obtain a sulfolane composition. The whole amount of each sulfolane composition thus obtained was put into a 500-mL flask, and further subjected to the heat stability tests 1 and 2. The results are shown in Table 2.

TABLE 2

| | Organic alkanolamine | Sulfur dioxide (mg/250 mL sulfolane) | |
|---|---|---|---|
| | compound | Heat stability | Heat stability |
| | Kind | test 1 | test 2 |
| Reference | Monoethanol amine | 4.5 | 5.1 |
| Example 1 | | | |
| Reference | Monoethanol amine | 4.3 | 5.2 |
| Example 2 | | | |

The results of Reference Examples 1 and 2 show that the sulfolane compounds mixed with an organic alkanolamine compound produced a reduced amount of sulfur dioxide and suppressed pyrolysis of the sulfolane compound even after the heating treatments for the heat stability tests and the simple distillation were repeated. The sulfolane compositions of the present invention when used as a solvent can therefore keep suppressing pyrolysis even when repeatedly recycled through heating and distillation.

### INDUSTRIAL APPLICABILITY

The present invention can provide a sulfolane composition which is not likely to cause odor and discoloration, can suppress pyrolysis of the sulfolane compound, and can reduce generation of sulfur dioxide. The sulfolane composition of the present invention when used as a solvent can keep suppressing pyrolysis even when repeatedly recycled through heating and distillation.

1. A sulfolane composition comprising
a sulfolane compound represented by formula (1) and
an organic alkanolamine compound, 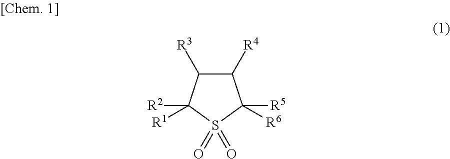
wherein R¹ to R⁶ each independently represent a hydrogen atom or a C₁₋₆ alkyl group.

2. The sulfolane composition according to claim 1,
wherein the organic alkanolamine compound is at least one selected from the group consisting of primary alkanolamine compounds, secondary alkanolamine compounds, and tertiary alkanolamine compounds.

3. The sulfolane composition according to claim 1,
wherein the organic alkanolamine compound is at least one selected from the group consisting of monoethanolamine, diethanolamine, triethanolamine, monoisopropanolamine, diisopropanolamine, and triisopropanolamine.

4. The sulfolane composition according to claim 1,
wherein an amount of the organic alkanolamine is 0.0001 to 0.4 parts by mass for each 100 parts by mass of the sulfolane compound.
